(19) United States
(12) Patent Application Publication
(10) Pub. No.: US 2024/0368769 A1
(43) Pub. Date: Nov. 7, 2024

(54) NONFERROUS METAL CORROSION INHIBITORS AND METHODS OF USING SAME

(71) Applicant: Solugen, Inc., Houston, TX (US)

(72) Inventors: Donald A. Johnson, Batavia, IL (US); Jun Su An, Houston, TX (US); Chris Arceo, Richmond, TX (US); Darlen Galicia, Houston, TX (US); LoongYi Tan, Houston, TX (US); Frederyk Ngantung, Houston, TX (US)

(73) Assignee: Solugen, Inc., Houston, TX (US)

(21) Appl. No.: 18/567,837

(22) PCT Filed: Jun. 24, 2022
(86) PCT No.: PCT/US2022/073146

§ 371 Date: Dec. 7, 2023

Related U.S. Application Data
(60) Provisional application No. 63/215,392, filed on Jun. 25, 2021.
(60) Provisional application No. 63/228,567, filed on Aug. 2, 2021.

(51) Int. Cl. C23F 11/12

(52) U.S. Cl. CPC C23F 11/12

(57) ABSTRACT

A corrosion inhibitor for nonferrous metals, comprising (i) a biochelant; (ii) a solvent; and (iii) at least one material selected from the group consisting essentially of a ring opener, an organic acid, a typical corrosion inhibitor, and a combination thereof. A method for reducing corrosion in a system comprising industrial water and a metal surface comprising introducing to the system a corrosion inhibitor composition comprising: (i) a biochelant; (ii) a solvent; and (iii) at least one material selected from the group consisting essentially of a ring opener, an organic acid, a typical corrosion inhibitor, and a combination thereof.

### CROSS-REFERENCE TO RELATED APPLICATIONS

This application is a 35 U.S.C. § 371 national stage application of PCT/US2022/073146 filed Jun. 24, 2022, and entitled “Nonferrous Metal Corrosion Inhibitors and Methods of Using Same,” which claims priority to U.S. Provisional Application Ser. No. 63/215,392 filed Jun. 25, 2021 and entitled “ALUMINUM CORROSION INHIBITORS AND METHODS OF USING SAME,” and U.S. Provisional Application Ser. No. 63/228,567 filed Aug. 2, 2021 and entitled “COMPOSITIONS AND METHODS FOR INHIBITING WHITE RUST,” each of which is incorporated herein by reference in its entirety for all purposes.

### BACKGROUND

Water is corrosive by nature because it is prone to reactions that result in the release of hydrogen atoms. Water-utilizing systems typically introduce corrosion inhibitors to the systems in order to prolong the service life of system components such as pipes and conduits.

Corrosion is the result of a complex series of reactions. For example, corrosion can occur between water and metal surfaces (e.g., metal piping) and materials in which the water is stored or transported. The corrosion process is an oxidation/reduction reaction that results in refined or processed metal being changed to their more stable state. Two major classes of non-ferrous metal-containing materials are aluminum-containing materials and zinc-containing materials.

Corrosion of aluminum-containing materials (e.g., aluminum alloy) is typically addressed by the use of soluble silicate salts (Inorganic Acid Technology-IAT) in closed loop cooling systems. IAT inhibitors were designed when engines were mainly constructed from ferrous alloys. To achieve satisfactory ferrous metal corrosion inhibition, IAT inhibitors are typically buffered to a pH in the range of 10-11 using borate buffers. This pH range is not optimal for aluminum corrosion control, and hence such inhibitors often included silicate salts, which are well-known aluminum corrosion inhibitors. However, when hard water is introduced into cooling systems treated with these inhibitors, calcium and magnesium silicates precipitate, causing harmful deposits and loss of corrosion inhibition effectiveness. Modern internal combustion engines contain more aluminum and less ferrous alloys than those of the previous generation, increasing the relative importance of aluminum corrosion control.

Another type of corrosion inhibitor for aluminum-containing materials utilizes Organic Acid Technology (OAT) in closed loop systems. OAT utilizes mixtures of aliphatic monobasic and dibasic acid salts such as benzotriazole, mercaptobenzothiazole, tolytriazole and their derivatives which have been found effective as corrosion inhibitors at high dosages. These inhibitors contain buffers that control the pH of the composition in the range of 8-9 with mixtures of monobasic and dibasic aliphatic acids such as sebacic and heptanoic acids. OAT inhibitors may also contain some inorganic components such as silicates and nitrites, in which are referred to as “Hybrid Technology”. However, these hybrid technologies also suffer from the negative effects of hard water precipitates and toxicity issues.

Another form of non-ferrous corrosion occurs with aqueous corrosion of the zinc layer of galvanized steel. This results in a voluminous friable layer of corrosion product commonly known as “white rust.” White rust is a white, chalky substance that can form on the surface of zinc materials, like galvanized steel. A common mechanism to mitigate the formation of white rust involves adjusting the chemistry of the aqueous fluids contacting the galvanized steel to conditions that disfavor white rust formation. This mechanism of mitigating white rust formation is suboptimal as it necessitates continuous monitoring and potential adjustments to the fluid composition to ensure the conditions remain disfavorable to white rust formation.

An ongoing need exists for novel corrosion inhibitors for non-ferrous metal-containing materials that are not characterized by the aforementioned drawbacks.

### BRIEF DESCRIPTION OF DRAWINGS

For a detailed description of the aspects of the disclosed processes and systems, reference will now be made to the accompanying drawings in which:

FIG. 1 is a graph of the corrosion rate as a function of time for the samples from Example 1.

FIG. 2 illustrates photographs of coupons exposed to the samples of Example 2.

### SUMMARY

Disclosed herein is a corrosion inhibitor for nonferrous metals, comprising (i) a biochelant; (ii) a solvent; and (iii) at least one material selected from the group consisting essentially of a ring opener, an organic acid, a typical corrosion inhibitor, and a combination thereof.

Also disclosed herein is a method for reducing corrosion in a system comprising industrial water and a metal surface comprising introducing to the system a corrosion inhibitor composition comprising: (i) a biochelant; (ii) a solvent; and (iii) at least one material selected from the group consisting essentially of a ring opener, an organic acid, a typical corrosion inhibitor, and a combination thereof.

Also disclosed herein is a system comprising at least one metal surface, a corrosion inhibitor, and industrial water wherein the corrosion inhibitor comprises from about 0.5 wt. % to about 70 wt. % of a biochelant based on the total weight of the corrosion inhibitor and the system comprises a boiler, a cooling tower, a cooling system, a closed recirculating cooling system, or dry cooling tower; an open recirculating system, or an internal combustion engine.

### DETAILED DESCRIPTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied.

Groups of elements of the periodic table are indicated using the numbering scheme indicated in the version of the periodic table of elements published in Chemical and Engineering News, 63 (5), 27, 1985. In some instances, a group of elements can be indicated using a common name assigned to the group; for example, alkali metals for Group 1 elements, alkaline earth metals for Group 2 elements, transition metals for Group 3-12 elements, and halogens for Group 17 elements, among others.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. While compositions and methods are described in terms of “comprising” various components or steps, the compositions and methods can also “consist essentially of” or “consist of” the various components or steps.

Disclosed herein are corrosion inhibitors of non-ferrous metal-containing materials exposed to a fluid such as an aqueous fluid. In an aspect, the compositions disclosed herein generally reduce the amount of deposition of a material onto a metal-containing surface and/or the chemical alteration of the metal-containing surface. In one or more aspects. the metal-containing surface is a component of an equipment and corrosion is detrimental to the equipment and/or process utilizing the equipment.

In an aspect, the metal-containing surface comprises zinc. In another aspect, the metal-containing surfaces comprises aluminum. Herein, corrosion inhibitor compositions formulated to reduce the corrosion of zinc-containing surfaces (e.g., galvanized steel) are termed corrosion inhibitor compositions for zinc and designated ClC—Zn. Herein, corrosion inhibitor compositions formulated to reduce the corrosion of aluminum-containing surfaces (e.g., aluminum alloy) are termed corrosion inhibitor compositions for aluminum and designated ClC—Al.

In an aspect, the corrosion inhibitors disclosed herein reduce corrosion of metal-containing surfaces exposed to aqueous fluids. In an aspect, the aqueous fluids comprises industrial water. Herein, “industrial water” refers to water used in an industrial operation such as fabricating, processing, washing, diluting, cooling, or transporting a product; incorporating water into a product; or for sanitation needs. In an aspect, the industrial water is a feed water. Herein, a feed water refers to water used in boilers and cooling towers to ensure or enhance efficiency, maximize boiler and system life, reduce maintenance costs, maintain levels of operational performance, or the like. In one or more aspects, the industrial water is present in a cooling system such as a once-through cooling system, a closed recirculating cooling system, or dry cooling tower; or an open recirculating system such as a wet cooling tower or evaporative cooling tower. In another aspect, industrial water facilitates the cooling of a modern internal combustion engine.

In an aspect, a ClC—Al and a ClC—Zn comprises a chelant. Herein a chelant, also termed a sequestrant, a chelating agent or sequestering agent, refers to a molecule capable of bonding or forming a complex with a metal. The chelant may be characterized as a ligand that contains two or more electron-donating groups so that more than one bond is formed between an atom on each of the electron donating groups of the ligand to the metal. This bond can also be dative or a coordinating covalent bond meaning each electronegative atom provides both electrons to form bonds to the metal center. In an aspect, the chelant is a biochelant. Herein the term “biochelant” refers to a molecule able to chelate a metal, as described, and (i) is sourced from a natural resource, (ii) is biodegradable or both.

In an aspect, the biochelant comprises aldonic acid, uronic acid, aldaric acid, or a combination thereof and a counter cation. For example, the biochelant may be a mixture of aldaric, uronic acids, and their respective counter-cations.

In another aspect, the biochelant comprises a glucose oxidation product, a gluconic acid oxidation product, a gluconate, or a combination thereof. The glucose oxidation product, gluconic acid oxidation product, or combination thereof may be buffered to a suitable pH.

Additionally, or alternatively, in one or more aspects, the biochelant comprises glucaric acid, gluconic acid, glucuronic acid, glucose oxidation products, gluconic acid oxidation products or a combination thereof. Additionally, or alternatively, in one or more aspects, the biochelant comprises disaccharides, oxidized disaccharides, uronic acid, aldaric acid or a combination thereof.

Additionally, or alternatively, in one or more aspects, the biochelant comprises gluconic acid, glucaric acid, glucuronic acid, n-keto-acids. C₂ to C₆ diacids or a combination thereof.

Additionally, or alternatively, in one or more aspects, the biochelant comprises galactonic acid, galactaric acid, an oxidation product comprising predominantly (e.g., greater than about 50 weight percent) galactonic acid and/or galactaric acid with minor component species of n-keto-acids, C₂ to C₆ diacids or a combination thereof. Additionally, or alternatively, in one or more aspects, the biochelant comprises glutamic acid. Additionally, or alternatively, in one or more aspects, the biochelant comprises glucodialdose, 2-ketoglucose or a combination thereof.

In such aspects, the buffered glucose oxidation product, the buffered gluconic acid oxidation product, or combinations thereof are buffered to a suitable pH. For example, the glucose oxidation product, gluconic acid oxidation product or combination thereof may be buffered to a pH in the range of from about 1 to about 5. Buffering of the chelant may be carried using any suitable acid, base or combination thereof.

In one or more aspects, any biochelant or combination of biochelants disclosed herein may further comprise a counter-cation such as a Group 1 alkali metal, a Group 2 alkaline earth metal, a Group 8 metal, Group 11 metal, Group 12 metal or a combination thereof. For example, the counter-cation may comprise silicates, borates, aluminum, calcium, magnesium, ammonium, sodium, potassium, cesium, strontium, zinc, copper, ferric iron or ferrous iron, or a combination thereof.

In an aspect, the biochelant comprises a glucose oxidation product, a gluconic acid oxidation product, a gluconate, glucaric acid, an oxidized glucuronolactone, a uronic acid oxidation product or a combination thereof. Alternatively, the biochelant comprises a buffered glucose oxidation product, a buffered gluconic acid oxidation product or combinations thereof. In some such aspects, the buffered glucose oxidation product, the buffered gluconic acid oxidation product, or combinations thereof are buffered to a pH within a range disclosed herein with any suitable acid or base such as sodium hydroxide. In an example of such aspects, the biochelant comprises a mixture of gluconic acid and glucaric acid and further comprises a minor component species comprising n-keto-acids, C₂-C₆ diacids or combinations thereof. In an aspect, the biochelant comprises a metal chelation product commercially available from Solugen, Houston Texas as BIOCHELATE™.

In various aspects, the chelant may be present in a corrosion inhibitor composition of the type disclosed herein (e.g., ClC—Al or ClC—Zn) in an amount of from about 0.5 weight percent (wt. %) to about 70 wt. %, alternatively from about 5 wt. % to about 50 wt. %, alternatively, from about 10 wt. % to about 60 wt. %, alternatively, from about 0.5 wt. % to about 10 wt. %, or alternatively, from about 20 wt. % to about 70 wt. % based on the total weight of the corrosion inhibitor composition. Herein, all weight percentages are based on the total weight of the composition being described unless indicated otherwise.

In one or more aspects, a corrosion inhibitor composition of the present disclosure may exclude the use of chelating agents other than those disclosed as biochelants herein. Further, in one or more other aspects, a corrosion inhibitor of the present disclosures excludes the use of other compounds known to function as corrosion inhibitors, herein termed “typical corrosion inhibitors.”

In an aspect, the typical corrosion inhibitor comprises heterocyclic organic compounds, molybdates, phosphates, or combinations thereof.

In an aspect, the typical corrosion inhibitor comprises a heterocyclic organic compound, alternatively a thiazole, a triazole, or a combination thereof. Thiazoles and triazoles are five-atom aromatic ring molecules that contain a nitrogen atom and at least one other nitrogen, oxygen, or sulfur atom as part of the ring. The azole-based compounds can be divided into three major classes, namely, N-, N&O-, and N&S-containing azole sets.

In an aspect, the conventional corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazole, tolytriazole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, chlorotolyltriazole, derivatives thereof, or a combination thereof.

In an aspect, the typical corrosion inhibitor comprises a molydate. For example, the typical corrosion inhibitor may comprise molybdate salts (including heteropolymolybdates). In an aspect, the typical corrosion inhibitor comprises an alkali metal salt of molybdate.

In an aspect, the typical corrosion inhibitor is a phosphorous-containing compound. Nonlimiting examples of phosphorus-containing compounds suitable for use in the present disclosure include aminotrimethylene phosphonic acid (ATMP), 1-hydroxyethylidene-1,1-diphosphonic acid (HEDP), hydrolzed polymaleic anhydride (HPMA), 2-hydrophosphonocarboxylic (HPAA), polyamino polyether phosphonate (PAPEMP), aminoethlethanolamine (AEEA), diethylenetriamine penta (DTPMP), bis (hexamethylene triamine penta (methylene phosphonic acid)) (BHMT), diethylene triamine penta (methylene phosphonic acid) (BTPMP), 2-phosphonobutane-1,2,4-tricarboxylic acid (PBTC), anionic polymers or copolymers with phosphorous functional groups incorporated in the polymer chain.

In an aspect, the corrosion inhibitor composition of the present disclosure may include the use of any typical corrosion inhibitor in combination with the chelating agents disclosed as biochelants herein. In some aspects, the typical corrosion inhibitor is present in the corrosion inhibitor composition in an amount of from about 0.5 wt. % to about 60 wt. %, alternatively from about 5 wt. % to about 50 wt. %, alternatively from about 10 wt. % to about 60 wt. %, or alternatively from about 0.5 wt. % to about 10 wt. %.

In an aspect the corrosion inhibitor is a ClC—Al and reduces the amount of corrosion occurring on a surface comprising aluminum and/or an aluminum alloy. In such aspects, in addition to a biochelant and optional typical corrosion inhibitor, the ClC—Al further comprises a solvent, and at least one material selected from the group consisting of a ring opener, an organic acid, or a combination thereof.

In an aspect, a ClC—Al of the present disclosure comprises a ring opener. Without wishing to be limited by theory, the biochelants disclosed herein exist in an equilibrium between the carboxylic acid and lactone form of the disclosed compounds. The carboxylic acid form of the disclosed biochelants are responsible for chelating metal ions that function to corrode metal surfaces of the type disclosed herein. The ring opener, when associated with the linear form of the biochelant, shifts the equilibrium to favor retention of the linear form of the biochelant and ensure the amount of the lactone form is reduced or minimized. The equilibrium shift the ring opener induces increases the amount of biochelant available to coordinate cations that contribute to corrosion.

In an aspect, the ring opener is a lanthanide-containing compound. A lanthanide suitable for use in the present disclosure is any member of the lanthanide series, for example, lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). In some aspects, the oxidation state of any of the lanthanides described herein is +3, for example, Nd (II), Pm (II), Eu (II), Gd (II), Tb (II), Dy (II), Ho (II), Er (II), Tm (Il), Yb (II), or Lu (II). In some aspects, the oxidation state of any of the lanthanides described herein is +3, for example, Nd (III), Pm (III), Eu (III), Gd (III), Tb (III), Dy (III), Ho (III), Er (III), Tm (III), Yb (III), or Lu (III). In an aspect, the lanthanide is associated with an anion to form a lanthanide salt.

In an aspect, the ring opener is an aluminate (AlO₂_{^{−}}). In one or more aspects, the ring opener is an aluminate salt, such as an alkali metal salt or an alkaline earth metal salt.

In an aspect, the ring opener is present in the ClC—Al in an amount of from about 0.01 wt. % to about 80 wt. %, alternatively from about 10 wt. % to about 80 wt. % based on the total weight of the composition, alternatively from about 5 wt. % to about 20 wt. % or alternatively from about 0.01 wt. % to about 5 wt. %.

In an aspect, the ClC—Al of the present disclosure comprises an organic acid. Herein an organic acid refers to an organic compound that is characterized by weak acidic properties and does not dissociate completely in the presence of water. In general, any organic acid compatible with the other components of the ClC—Al and able to provide acidic species may be utilized. Nonlimiting examples of organic acids suitable for use in the present disclosure include citric acid, lactic acid, acetic acid, formic acid, oxalic acid, uric acid, malic acid, tartaric acid, and combinations thereof.

In an aspect, the organic acid is present in the ClC—Al in an amount of from about 0.01 wt. % to about 70 wt. %, alternatively from about 0.1 wt. % to about 70 wt. % alternatively from about 0.1 wt. % to about 15 wt. % or alternatively from about 0.01 wt. % to about 2.5 wt. %.

In an aspect, a ClC—Al of the present disclosure further comprises a solvent. In general, any solvent compatible with the ClC—Al and/or activity to be undertaken may be utilized. In an aspect, the solvent comprises water, an alcohol, and/or a polyol. In an aspect, the polyol can be an aliphatic polyol such as ethylene glycol, diethylene glycol, triethylene glycol, tetraethylene glycol, tripropylene glycol 1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof. Non-limiting examples of suitable alcohols that can be utilized as a solvent include methanol, ethanol, propanol, isopropanol, n-butanol, isobutanol, pentanol, hexanol, heptanol, octanol, benzyl alcohol, phenol, cyclohexanol, and the like, and combinations thereof. In an aspect, the solvent comprises water, methanol, ethanol, ethylene glycol, propylene glycol, or a combination thereof.

In an aspect, the solvent may be present in an amount of from about 10% to about 100% based on the total volume of the composition. In an alternative aspect, solvent may be present in the ClC—Al in an amount that constitutes the remainder of the composition once all other components are accounted for.

In an aspect, the ClC—Zn comprises a biochelant, a metal counterion, one or more typical corrosion inhibitors and a solvent. Biochelants, metal counterions and typical corrosion inhibitors may be of the type disclosed herein. In an aspect, these materials may be present in the ClC—Zn in the amounts also previously disclosed herein for the ClC—Al.

In an aspect, the ClC—Zn further comprises a solvent. In general, any solvent compatible with the ClC—Zn and/or activity to be undertaken may be utilized. In an aspect, the solvent comprises water, an alcohol, a polyol, or a combination thereof.

In an aspect, the solvent is a polyol. The polyol can be an aliphatic polyol such as ethylene glycol, diethylene glycol, triethylene glycol, tetraethylene glycol, tripropylene glycol 1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

In an aspect, the solvent is an alcohol. Non-limiting examples of suitable alcohols that can be utilized as a solvent include methanol, ethanol, propanol, isopropanol, n-butanol, isobutanol, pentanol, hexanol, heptanol, octanol, benzyl alcohol, phenol, cyclohexanol, and the like, and combinations thereof. In an aspect, the solvent comprises water, methanol, ethanol, ethylene glycol, propylene glycol, or a combination thereof.

In an aspect, the solvent may be present in an amount of from about 10% to about 100% based on the total volume of the ClC—Zn. In an alternative aspect, solvent may be present in the ClC—Zn in an amount that constitutes the remainder of the composition once all other components are accounted for.

In one or more aspects, a corrosion inhibitor composition of the type disclosed herein (e.g., ClC—Al, ClC—Zn, etc.) can be prepared using any suitable methodology. For example, two or more components of the corrosion inhibitor composition (e.g., biochelant and solvent) may be blended or mixed in a suitable vessel (e.g., container, blender etc.). In some aspects, the components of the corrosion inhibitor composition may be mixed to form a homogenous mixture that can subsequently be introduced to a system to facilitate corrosion inhibition

A corrosion inhibitor composition may be introduced to an aqueous system in amounts effective to facilitate some user and/or process targeted activity (e.g., corrosion inhibition). For example, to effectively inhibit corrosion, the corrosion inhibitor composition may have to be present at or above a certain concentration. The minimum inhibitor level required to prevent corrosion is commonly referred to as “minimum inhibitory concentration” (MIC) or “minimum effective concentration” (MEC). In one or more aspects, a system having a corrosion inhibitor composition introduced may be monitored to ensure the amount of the corrosion inhibitor composition retains some MIC or MEC for that particular system.

In some aspects, the MIC or MEC for the active components (e.g., the components other than the solvent) of the ClC—Zn and/or the ClC—Al can range from about 1 ppm to about 100 ppm by weight, alternatively from about 5 to about 50 ppm by weight, or alternatively from about 10 to about 30 ppm by weight in the aqueous fluid in the system.

In one or more aspects, a corrosion inhibitor composition of the type disclosed herein may also function to inhibit the formation of scale. Herein, scale refers to hard mineral coatings and corrosion deposits made up of solids and sediments that collect on or in distribution systems, piping, storage reservoirs and water conduits. In an aspect, a corrosion inhibitor composition of the type disclosed herein may reduce scaling in a system comprising industrial water to an amount that is from about 10% to about 90%, alternatively from about 20% to about 80% or alternatively from about 30% to about 80% of the amount of scale formed in the absence of a corrosion inhibitor composition of the type disclosed herein.

Aqueous systems to which the corrosion inhibitor composition may be introduced can further comprise calcium ions, magnesium ions, or both. In an aspect, the corrosion inhibitor composition is introduced to a system using any suitable methodology. For example, a ClC—Zn and/or a ClC—Al may be injected at an appropriate system input, such as at a port or valve that allows the ClC—Zn and/or a ClC—Al to contact the aqueous system. In an aspect, a method of the present disclosure further comprises monitoring and adjusting the corrosion inhibitor composition level to maintain a level of the amount of composition in the system in some user and/or process desired range. In an aspect, a corrosion inhibitor composition of the type disclosed herein may be introduced to a system manually. In an alternative aspect, the corrosion inhibitor composition introduction may be automated. A method may be developed to monitor the concentration of corrosion inhibitor composition in a system. Monitoring of the corrosion inhibitor composition dosage in a system may be continuous, semi-continuous, discrete, automated, manual, or a combination thereof.

The method can be programmed into a device such as a pump to deliver an amount of the corrosion inhibitor composition that results in some predefined dose that is at least the MIC or MEC for that particular system. The method may be automated by use of any suitable supply device such as a material feeder or pump such as a programmable pump. The device such as a pump can be programmed to operate at specific times for specific run time intervals to add maintenance doses of corrosion inhibitor composition to the volume of water undergoing treatment.

In an aspect, the corrosion inhibitor composition of the present disclosure surprisingly displays increased corrosion inhibition when compared to typical corrosion inhibitors. For example, a ClC—Al having a biochelant, organic acid, and typical corrosion inhibitor (e.g., triazole) displays an unexpectedly beneficial increase in corrosion inhibition of from about 10% to about 100%, alternatively from about 70% to about 90% or alternatively from about 90% to about 99% when compared to the corrosion inhibition observed with the typical corrosion inhibitor alone.

In some aspects, a synergistic effect is observed when a corrosion inhibitor composition of the type disclosed herein is utilized in conjunction with a typical corrosion inhibitor (e.g., triazole). This may result in a reduction in the minimal concentration of typical corrosion inhibitor needed to effectively address a corrosion issue. In other words, with the addition of a corrosion inhibitor composition of the type disclosed herein, the amount of typical corrosion inhibitor needed to achieve the same level of corrosion inhibition may be reduced by equal to or greater than about 10%, alternatively equal to or greater than about 15% or equal to or greater than about 20%. The result is a reduction in the use of typical corrosion inhibitors with a concomitant reduction in cost and environmental impact associated with production and use of these compounds.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

The effectiveness of corrosion inhibitor compositions were evaluated. Specifically, the corrosion rate in mils per year (mpy) of an aluminum coupon was determined for (1) a blank sample containing only the brine solution (no additives); (2) a ClC—Al comprising a 84% glucaric acid solution and 16% LaCls salt; (3) a ClC—Al comprising a 53.6% glucaric acid solution; (4) a ClC—Al comprising a 31.4% sodium aluminate solution, a 53.6% glucaric acid solution, and a 15% sodium hydroxide solution; and (5) 4 ppm of sodium tolytriazole (TTA). The corrosion rate was determined under test conditions of a 100% water cut, a 3% NaCl brine, a rotation speed of 100 rpm, a pH of 8, and a reaction time of 24 hours using an aluminum coupon.

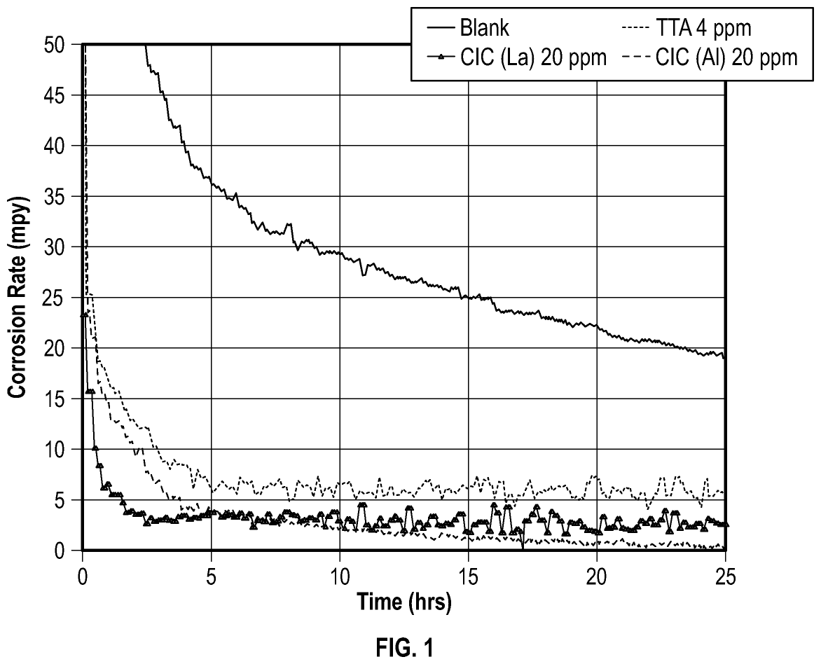

Table 1 presents the results of the experiment in terms of the amount of corrosion observed in mpy after 24 hours while FIG. 1 displays the corrosion rate as a function of time for the samples.

TABLE 1

| Sample Composition of Al | MPY @ 24 hrs |
|---|---|
| Blank | 19.5 |
| TTA 4 ppm | 4.3 |
| BC Pro Max (La) + TTA | 2.8 |
| BC Pro Max (Al) + TTA | 0.4 |

The results demonstrate that surprisingly the corrosion inhibiting compositions of the type disclosed herein offered significantly better aluminum alloy corrosion inhibition than the uncomplexed acids and other compounds. The corrosion inhibiting compositions of the type disclosed herein that contained aluminum or lanthanum complexes displayed the greatest level of corrosion inhibition.

### Example 2

The efficacy of a ClC—Zn as a corrosion inhibitor of galvanized steel was evaluated. Specifically, a set of galvanized coupons were subjected to a week-long corrosion test that simulated severe corrosion conditions that were characterized by high chloride content and low alkalinity. The specific conditions were the use of a galvanized coupon that was air purged before being subjected to 25 ppm alkalinity, 2000 ppm chloride at a pH between 8 and 8.5 at a temperature of 40° C. for 1 week. The coupons were weighed before the test and after the test, so that the corrosion rate could be calculated. The results of the test are presented in Table 2.

TABLE 2

| | Run | Carboxylic | Carboxylic | Tolytriazole | |
|---|---|---|---|---|---|
| Run # | Description | Acid ppm | acid type | ppm | MPY |
| 1 | TTA | 0 | NA | 4 | 6.28 |
| 2 | CIC-Zn (C6 | 10 | Glucaric | 0 | 3.54 |
| | diacid) | | | | |
| 3 | CIC-Zn (C6 | 10 | Glucaric | 4 | 1.50 |
| | diacid) + | | | | |
| | TTA | | | | |
| 4 | CIC-Zn (C6 | 10 | Glucaric + | 0 | 0.36 |
| | diacid salt) | | aluminate | | |
| 5 | CIC-Zn (C6 | 10 | Glucaric + | 4 | 0.29 |
| | diacid salt) + | | sodium | | |
| | TTA | | silicate | | |

As seen in Table 2, the addition of glucaric acid to TTA yields performance improvements (6.28 MPY vs 3.54 MPY). Furthermore, the use of cations such as silicate and aluminate leads to formulations that either in the presence or absence of an azole, has a corrosion rate that is dramatically lower at 0.29 and 0.36 MPY, respectively.

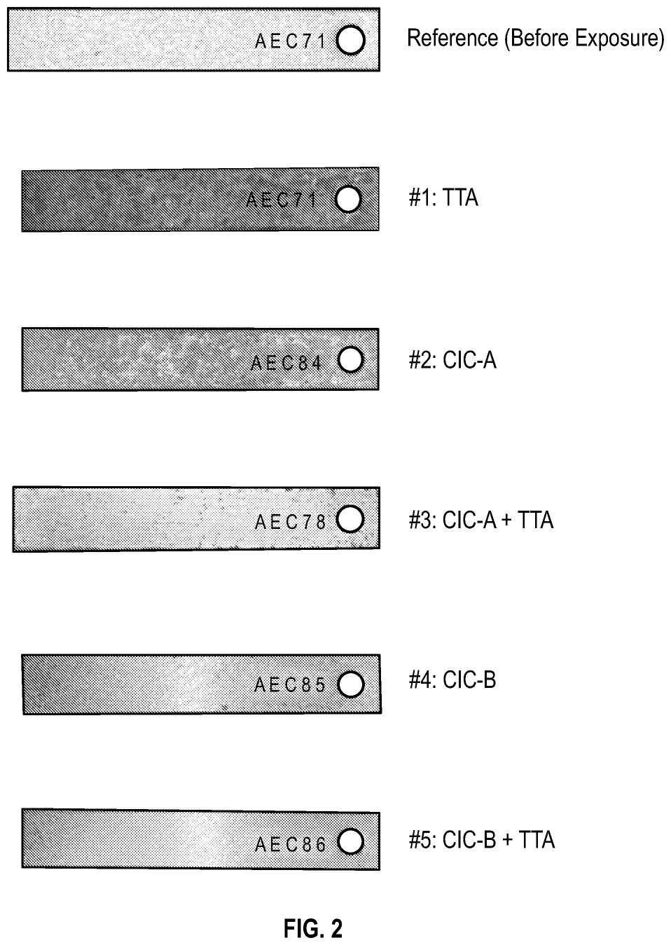

The coupon images for Runs 1-5 are presented in FIG. 2. As seen in FIG. 2, the TTA alone (Run 1) generated a significant amount of white rust generation, and a high corrosion rate. The ClC—Zn alone or in the presence of TTA (#4, #5) exhibited the lowest corrosion rate and cleanest coupon.

### ADDITIONAL DISCLOSURE

The following enumerated aspects of the present disclosures are provided as non-limiting examples.

A first aspect which is a corrosion inhibitor for nonferrous metals, comprising: (i) a biochelant; (ii) a solvent; and (iii) at least one material selected from the group consisting essentially of a ring opener, an organic acid, a typical corrosion inhibitor, and a combination thereof.

A second aspect which is the corrosion inhibitor of the first aspect, wherein the biochelant comprises aldonic acid, uronic acid, aldaric acid, a gluconic acid oxidation product, a gluconate, glucaric acid, gluconic acid, glucuronic acid, glucose oxidation products, galactonic acid, galactaric acid, glutamic acid, glucodialdose, 2-ketoglucose, disaccharides, oxidized disaccharides, n-keto-acids, C₂ to C₆ diacids, salts thereof or combinations thereof.

A third aspect which is the corrosion inhibitor of any of the first through second aspects, wherein the biochelant comprises sodium gluconate, oxidation products of sodium glucarate, salts thereof, derivatives thereof, or a combination thereof.

A fourth aspect which is the corrosion inhibitor of any of the first through third aspects wherein the biochelant is present in an amount of from about 0.5 wt. % to about 70 wt. % based on the total weight of the corrosion inhibitor.

A fifth aspect which is the corrosion inhibitor of any of the first through fourth aspects wherein the ring opener comprises a lanthanide salt, an aluminate salt, or a combination thereof.

A sixth aspect which is the corrosion inhibitor of the fifth aspect wherein the lanthanide salt comprises lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu) or a combination thereof.

A seventh aspect which is the corrosion inhibitor of any of the first through sixth aspects wherein the organic acid comprises citric acid, lactic acid, acetic acid, formic acid, oxalic acid, uric acid, malic acid, tartaric acid, and combinations thereof

An eighth aspect which is the corrosion of any of the first through seventh aspects wherein the typical corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazo-2,4-olyltriazolezole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, derivatives thereof, or a combination thereof.

A ninth aspect which is the corrosion inhibitor of any of the first through eighth aspects wherein the typical corrosion inhibitor comprises a molybdate salt.

A tenth aspect which is the corrosion inhibitor of any of the first through ninth aspects wherein the typical corrosion inhibitor comprises aminotrimethylene phosphonic acid (ATMP), 1-hydroxyethylidene-1,1-diphosphonic acid (HEDP), hydrolzed polymaleic anhydride (HPMA), 2-hydrophosphonocarboxylic (HPAA), polyamino polyether phosphonate (PAPEMP), aminoethlethanolamine (AEEA), diethylenetriamine penta (DTPMP), bis (hexamethylene triamine penta (methylene phosphonic acid))) (BHMT), diethylene triamine penta (methylene phosphonic acid) (BTPMP), 2-phosphonobutane-1,2,4-tricarboxylic acid (PBTC), polymacrylates, maleic acid, polyaspartic acid and sodiumaspartic acid, phosphinocarboxylates, acrylic acid-2-acrylamido-2-methylpropane sulfonic acid (AA-AMPS), or combinations thereof.

An eleventh aspect which is the corrosion inhibitor of any of the first through tenth aspects wherein the solvent comprises water, ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1, 10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

A twelfth aspect which is a method for reducing corrosion in a system comprising industrial water and a metal surface comprising introducing to the system a corrosion inhibitor composition comprising: (i) a biochelant; (ii) a solvent; and (iii) at least one material selected from the group consisting essentially of a ring opener, an organic acid, a typical corrosion inhibitor, and a combination thereof.

A thirteenth aspect which is the method of the twelfth aspect wherein the metal surface comprises an aluminum-containing compound, a zinc-containing compound, or a combination thereof.

A fourteenth aspect which is the method of the twelfth through thirteenth aspects wherein the biochelant comprises aldonic acid, uronic acid, aldaric acid, glucose oxidation product, a gluconic acid oxidation product, a gluconate, glucaric acid, gluconic acid, glucuronic acid galactonic acid, galactaric acid, glutamic acid, glucodialdose, 2-ketoglucose, disaccharides, oxidized disaccharides, n-keto-acids, C₂ to C₆ diacids, salts thereof or combinations thereof.

A fifteenth aspect which is the method of any of the twelfth through fourteenth aspects wherein the ring opener comprises a lanthanide salt, an aluminate salt, or a combination thereof.

A sixteenth aspect which is the method of any of the twelfth through fifteenth aspects wherein the organic acid comprises citric acid, lactic acid, acetic acid, formic acid, oxalic acid, uric acid, malic acid, tartaric acid, and combinations thereof.

A seventeenth aspect which is the method of any of the twelfth through sixteenth aspects wherein the typical corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, 1,3,4-thiadiazole, benzotriazo2,4-olyltriazolezole, a derivative thereof, or a combination thereof.

An eighteenth aspect which is the method of any of the twelfth through seventeenth aspects wherein the organic acid comprises citric acid, lactic acid, acetic acid, formic acid, oxalic acid, uric acid, malic acid, tartaric acid, or a combination thereof.

A nineteenth aspect which is the method of any of the twelfth through eighteenth aspects wherein the solvent comprises water, ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

A twentieth aspect which is the method of any of the twelfth through nineteenth aspects wherein the system comprises a boiler, a cooling tower, a cooling system, a closed recirculating cooling system, or dry cooling tower; an open recirculating system, or an internal combustion engine.

A twenty-first aspect which is a system comprising at least one metal surface, a corrosion inhibitor, and industrial water wherein the corrosion inhibitor comprises from about 0.5 wt. % to about 70 wt. % of a biochelant based on the total weight of the corrosion inhibitor and the system comprises a boiler, a cooling tower, a cooling system, a closed recirculating cooling system, or dry cooling tower; an open recirculating system, or an internal combustion engine.

A twenty-second aspect which is the system of the twenty-first aspect wherein the metal surface comprises an aluminum-containing compound, a zinc-containing compound or a combination thereof.

A twenty-third aspect which is a corrosion inhibitor comprising at least two of the following: a biochelant; a solvent; and at least one material selected from the group consisting essentially of a ring opener, an organic acid, a conventional corrosion inhibitor, and a combination thereof.

A twenty-fourth aspect which is the corrosion inhibitor of the twenty-third aspect wherein the biochelant is a naturally-occurring molecule or derived from a naturally-occurring molecule such as monosaccharide or polysaccharide.

A twenty-fifth aspect which is the corrosion inhibitor or any of the twenty-third through twenty-fourth aspects wherein the biochelant comprises aldonic acid, uronic acid, aldaric acid, a salt thereof, a derivative thereof, or a combination thereof

A twenty-sixth aspect which is the corrosion inhibitor of any of the twenty-third through twenty-fifth aspects wherein the biochelant comprises sodium gluconate, oxidation products of sodium glucarate, one or more salts thereof, one or more derivatives thereof, or a combination thereof.

A twenty-seventh aspect which is the corrosion inhibitor of the twenty-sixth aspect wherein the biochelant further comprises n-keto acids and C₂-C₆ diacids in amounts of less than about 50 wt. %.

A twenty-eight aspect which is the corrosion inhibitor of any of the twenty-third through twenty-seventh aspects wherein the ring opener comprises a lanthanide salt, an aluminate salt, or a combination thereof.

A twenty-ninth aspect which is the corrosion inhibitor of any of the twenty-third through twenty-eighth aspects wherein the conventional corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, 1,3,4-thiadiazole, benzotriazole, tolytriazole, a derivative thereof, or a combination thereof.

A thirtieth aspect which is the corrosion inhibitor of any of the twenty-third through twenty-ninth aspects wherein the organic acid comprises citric acid, lactic acid, acetic acid, formic acid, oxalic acid, uric acid, malic acid, tartaric acid, or a combination thereof.

A thirty-first aspect which is the corrosion inhibitor of any of the twenty-third through thirtieth aspects, wherein the solvent comprises water, ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1, 10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

A thirty-second aspect which is the corrosion inhibitor of any of the twenty-third through thirty-first aspects wherein the solvent comprises water, methanol, ethanol, ethylene glycol, propylene glycol, ethylene glycol monobutyl ether, or a combination thereof.

A thirty-third aspect which is a method for reducing corrosion in a system comprising an aluminum or aluminum alloy surface, the method comprising introducing an aqueous solution comprising the corrosion inhibitor of any of the twenty-third through thirty-second aspects.

A thirty-fourth aspect which is an inhibitor of white rust in an aqueous system comprising zinc or galvanized steel, the inhibitor comprising a biochelant; a counterion; a conventional corrosion inhibitor; and a solvent.

A thirty-fifth aspect which is the inhibitor of the thirty-fourth aspect, wherein the biochelant is a naturally-occurring molecule or derived from a naturally-occurring molecule such as monosaccharide or polysaccharide.

A thirty-sixth aspect which is the inhibitor of any of the thirty-fourth through thirty-fifth aspects wherein the biochelant comprises aldonic acid, uronic acid, aldaric acid, a salt thereof, a derivative thereof, or a combination thereof.

A thirty-seventh aspect which is the inhibitor of any of the thirty-fourth through thirty-sixth aspects wherein the biochelant comprises sodium gluconate, oxidation products of sodium glucarate, one or more salts thereof, one or more derivatives thereof, or a combination thereof.

A thirty-eighth aspect which is the inhibitor of the thirty-seventh aspect wherein the biochelant further comprises n-keto acids and C₂-C₆ diacids in amounts of less than about 50 wt. %.

A thirty-ninth aspect which is the inhibitor of any of the thirty-fourth through thirty-eighth aspects wherein the conventional corrosion inhibitor comprises a thiazole, a triazole, or a combination thereof.

A fortieth aspect which is the inhibitor of any of the thirty-fourth through thirty-ninth aspects wherein the conventional corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazole, tolytriazole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, one or more derivatives thereof, or a combination thereof.

A forty-first aspect which is the inhibitor of any of the thirty-fourth through fortieth aspects wherein the conventional corrosion inhibitor comprises a molybdate salt.

A forty-second aspect which is the inhibitor of any of the thirty-fourth through forty-first aspects wherein the conventional corrosion inhibitor comprises ATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis (HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid and sodiumaspartic acid, phosphinocarboxylates, AA-AMPS (acrylic acid-2-acrylamido-2-methylpropane sulfonic acid), or a combination thereof.

A forty-third aspect which is the inhibitor of any of the thirty-fourth through forty-second aspects wherein the solvent comprises ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2.2,4-trimethyl-1,3-pentanediol, or a combination thereof.

A forty-fourth aspect which is the inhibitor of any of the thirty-fourth through forty-third aspects wherein the solvent comprises water, methanol, ethanol, ethylene glycol, propylene glycol, or a combination thereof.

A forty-fifth aspect which is the inhibitor of any of the thirty-fourth through forty-fourth aspects wherein the aqueous system comprises copper ions.

A forty-sixth aspect which is the inhibitor of any of the thirty-fourth through forty-fifth aspects wherein the counterion comprises silicon, silica silicon, silicates, aluminum, lanthanum, sodium, calcium, potassium, ammonium, boron, indium, or a combination thereof.

While aspects of the presently disclosed subject matter have been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A corrosion inhibitor for nonferrous metals, the corrosion inhibitor comprising:
(i) a biochelant;
(ii) a solvent; and
(iii) at least one material selected from the group consisting essentially of a ring opener, an organic acid, a typical corrosion inhibitor, and a combination thereof.

2. The corrosion inhibitor of claim 1, wherein the biochelant comprises aldonic acid, uronic acid, aldaric acid, a gluconic acid oxidation product, a gluconate, glucaric acid, gluconic acid, glucuronic acid, glucose oxidation products, galactonic acid, galactaric acid, glutamic acid, glucodialdose, 2-ketoglucose, disaccharides, oxidized disaccharides, n-keto-acids, C₂ to C₆ diacids, salts thereof, or a combination thereof.

3. The corrosion inhibitor of claim 1, wherein the biochelant comprises sodium gluconate, oxidation products of sodium glucarate, one or more salts thereof, one or more derivatives thereof, or a combination thereof.

4. The corrosion inhibitor of claim 1, wherein the biochelant is present in an amount of from about 0.5 wt. % to about 70 wt. % based on the total weight of the corrosion inhibitor.

5. The corrosion inhibitor of claim 1, wherein the ring opener comprises a lanthanide salt, an aluminate salt, or a combination thereof.

6. The corrosion inhibitor of claim 5, wherein the lanthanide salt comprises lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), or a combination thereof.

7. The corrosion inhibitor of claim 1, wherein the organic acid comprises citric acid, lactic acid, acetic acid, formic acid, oxalic acid, uric acid, malic acid, tartaric acid, or a combination thereof.

8. The corrosion inhibitor of claim 1, wherein the typical corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, mercaptobenzothiazole, mercaptobenzimidazole, butyl benzotriazole 1,3,4-thiadiazole, benzotriazo-2,4-olyltriazolezole, (2-pyrrole carbonyl) benzotriazole, (2-thienyl carbonyl)-benzotriazole, amino-1,2,4-triazole, diamino-1,2,4-triazole, mercapto-1H-1,2,4-triazole, methyl-2-phenyl-imidazole, amino-3-hydrazino-5-mercapto-1,2,4-triazole, phenyl-1-H-tetrazole, one or more derivatives thereof, or a combination thereof.

9. The corrosion inhibitor of claim 1, wherein the typical corrosion inhibitor comprises a molybdate salt.

10. The corrosion inhibitor of claim 1, wherein the typical corrosion inhibitor comprises aminotrimethylene phosphonic acid (ATMP), 1-hydroxyethylidene-1,1-diphosphonic acid (HEDP). hydrolzed polymaleic anhydride (HPMA), 2-hydrophosphonocarboxylic (HPAA), polyamino polyether phosphonate (PAPEMP), aminoethlethanolamine (AEEA), diethylenetriamine penta (DTPMP), bis (hexamethylene triamine penta (methylene phosphonic acid))) (BHMT), diethylene triamine penta (methylene phosphonic acid) (BTPMP), 2-phosphonobutane-1,2,4-tricarboxylic acid (PBTC), polymacrylates, maleic acid, polyaspartic acid and sodiumaspartic acid, phosphinocarboxylates, acrylic acid-2-acrylamido-2-methylpropane sulfonic acid (AA-AMPS), or a combination thereof.

11. The corrosion inhibitor of claim 1, wherein the solvent comprises water, ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

12. A method for reducing corrosion in a system comprising industrial water and a metal surface, the method comprising:
introducing to the system a corrosion inhibitor composition comprising:
(i) a biochelant;
(ii) a solvent; and
(iii) at least one material selected from the group consisting essentially of a ring opener, an organic acid, a typical corrosion inhibitor, and a combination thereof.

13. The method of claim 12, wherein the metal surface comprises an aluminum-containing compound, a zinc-containing compound, or a combination thereof.

14. The method of claim 12, wherein the biochelant comprises aldonic acid, uronic acid, aldaric acid, glucose oxidation product, a gluconic acid oxidation product, a gluconate, glucaric acid, gluconic acid, glucuronic acid galactonic acid, galactaric acid, glutamic acid, glucodialdose, 2-ketoglucose, disaccharides, oxidized disaccharides, n-keto-acids, C₂ to C₆ diacids, one or more salts thereof, or a combination thereof.

15. The method of claim 12, wherein the ring opener comprises a lanthanide salt, an aluminate salt, or a combination thereof.

16. The method of claim 12, wherein the organic acid comprises citric acid, lactic acid, acetic acid, formic acid, oxalic acid, uric acid, malic acid, tartaric acid, or a combination thereof.

17. The method of claim 12, wherein the typical corrosion inhibitor comprises imidazole, pyrazole, 1,2,3-triazole, 1,2,4-triazole, tetrazole, oxazole, isoxazole, 1,2,4-oxadiazole, 1,3,4-oxadiazole, thiazole, 1,2,4-thiadiazole, 1,3,4-thiadiazole, benzotriazo2,4-olyltriazolezole, a derivative thereof, or a combination thereof.

18. The method of claim 12, wherein the organic acid comprises citric acid, lactic acid, acetic acid, formic acid, oxalic acid, uric acid, malic acid, tartaric acid, or a combination thereof.

19. The method of claim 12, wherein the solvent comprises water, ethylene glycol, diethylene glycol, triethylene glycol, tetraethylene glycol, tripropylene glycol1,2-propanediol, 1,3-propanediol, 1,2-butanediol, 1,3-butanediol, 1,4-butanediol, 1,5-pentanediol, neopentyl glycol, 1,2-hexanediol, 1,6-hexanediol, 1,2-octanediol, 1,8-octanediol, 1,2-decanediol, 1,10-decanediol, glycerol, 2,2-dimethylolpropane, trimethylolethane, trimethylolpropane, pentaerythritol, dipentaerythritol, sorbitol, 1,2,4-butanetriol, 2,2,4-trimethyl-1,3-pentanediol, or a combination thereof.

20. The method of claim 12, wherein the system comprises a boiler, a cooling tower, a cooling system, a closed recirculating cooling system, or dry cooling tower;
an open recirculating system, or an internal combustion engine.

21. A system comprising at least one metal surface, a corrosion inhibitor, and industrial water wherein the corrosion inhibitor comprises from about 0.5 wt. % to about 70 wt. % of a biochelant based on the total weight of the corrosion inhibitor and the system comprises a boiler, a cooling tower, a cooling system, a closed recirculating cooling system, or dry cooling tower, an open recirculating system, or an internal combustion engine.

22. The system of claim 21, wherein the metal surface comprises an aluminum-containing compound, a zinc-containing compound, or a combination thereof.
